(19) United States
(12) Patent Application Publication
(10) Pub. No.: US 2016/0321034 A1
(43) Pub. Date: Nov. 3, 2016

(54) USER EXPERIENCE AS A SERVICE

(71) Applicant: SAP SE, Walldorf (DE)

(72) Inventors: Samuel J. Yen, Los Altos, CA (US); Anamarie Huerta Franc, Hillsborough, CA (US); Adi Kavaler, Sunnyvale, CA (US)

(21) Appl. No.: 14/971,388

(22) Filed: Dec. 16, 2015

Related U.S. Application Data
(60) Provisional application No. 62/155,691, filed on May 1, 2015.

(51) Int. Cl. G06F 9/44; G06F 17/30

(52) U.S. Cl. CPC G06F 8/20; G06F 17/30979; G06F 9/4446

(57) ABSTRACT

A method, a system, and a computer readable storage medium for configuring a design platform to maximize a design experience and the needs of the designer while addressing a business concern. The configuration is further adjusted as necessary to account for changes based on the needs of the user, changes in a design experience level of the user, and changes in the business concern. The dynamically adapting design platform provides a streamlined user experience that addresses business concerns of the user while maintaining efficient design and a scalable and iterative approach. To provide functionality that maximizes the experience of the designer different tools are implemented in a cloud computing environment that encourage community and collaboration, integrated prototyping tools, and virtual design up skilling.

### RELATED APPLICATIONS

This application claims priority to U.S. Patent Application Ser. No. 62/155,691, filed on May 1, 2015, the content of which is incorporated herein in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### FIELD

A method, device, system, and computer program product that relate to configuring a cloud based design platform to meet a user's needs while addressing a business concern and adjusting the design platform to account for changes in the user's needs; and in addition, embodiments of the present invention relate to a cloud based environment having a library that hosts at least one configuration file or executable file that provides a user tailored component to streamline a design platform.

### BACKGROUND

Employees and leaders in business industries have numerous business concerns across a wide range of fields that require design solutions. Different targeted vendors supply the employees and leaders with design solutions for each of these business concerns. The targeted vendors provide desirable services because their end result is professional and tailored to the business needs. Vendors frequently employ or acquire design agencies so that a designer can innovate in view of a specific business concern, and then the innovation sparked by the sole designer is propagated through teams of developers to vendors until the product is ready for customers.

To provide the requested solution, the vendors address specific business concerns through a production process. The production process requires that the vendor: 1) determine the scope of the problem to be solved; 2) researches the problem and the possible solutions to the problem; 3) synthesizes and ideates the solution to the problem; 4) generates a prototype; 5) verifies and validates the prototype; and 6) implements the solution. The solution is implemented by a deployment of the product addressing the specific business needs. In some instances, a software development process is the production process or a portion of the production process.

However, the targeted vendor production process described above is similar to a traditional waterfall development process and results in several different problems when it is used in conjunction with a user design platform. Sequential design processes, such as the production process described above, are difficult to scale. It is difficult to increase the volume of the user design platform solutions while maintaining the targeted nature of the solutions and the quality of the solutions that are conceived of by a single designer. Further, the production process described above is inefficient. In order to cycle through the above described steps of the production process, communication between those employees closest to the problem, those in the business, and those designing the solution must be constant, which detracts from the employee's role in the business and requires significant effort. The foregoing problems are exacerbated because in the current technology based market, the lifecycle of a design solution or a design product is fairly short. Iteration of a sequential time consuming production process to generate solutions that are implemented only briefly is not effective or efficient. Cost is also a concern. The vendor production process has numerous players working to find viable solutions over a long duration. Furthermore, in the technology industry, multiple businesses (or even divisions within the same business) have similar business concerns that need to be addressed with design solutions. However, the tailored production process approach fails to propagate, or share, design solutions for the initial targeted business concern among multiple businesses having the same business concerns.

Incremental solutions to the above described problems with waterfall development have been introduced with Agile Development methodology, Platform as a Service (PaaS), and Software as a Service (SaaS), each of which enables greater scale, higher quality, lower cost, and faster time to delivery for application development. However, these solutions fail to address inefficiencies with the user experience that result from development processes similar to the waterfall development process. Solution-driven responses to business concerns generally provide minimal attention to end user needs in view of the greater timeline based solution concerns. However, the end users best understand the intricacies of the problem associated with the business concern, and they are arguably in the best position to design and to evaluate the success of the design for the business concern.

Accordingly, a there is a need for user experience based design and design process that addresses business concerns while enabling greater scale, higher quality, lower cost, and faster time to delivery for development of a design solution to the business concerns.

### BRIEF DESCRIPTION OF THE DRAWINGS

FIG. 1 is an illustration of an example tool-based approach included in the user experience as a service platform.

FIG. 2A is an illustration of an example user interface portal 200 to access the user experience as a service platform.

FIG. 2B is an illustration of the example user interface portal 200 to customize the user experience as a service platform.

FIG. 2C is an illustration of the example user interface portal 200 to account for initial user input regarding the user experience as a service platform.

FIG. 2D is an illustration of the example rich user interface 200 of the user experience as a service platform according to one example configuration.

FIG. 2E is an illustration of the example rich user interface 200 of the user experience as a service platform according to an example configuration different than the configuration presented in FIG. 2D.

FIG. 3A is an illustration of an example functional architecture of the user experience as a service platform 300.

FIG. 3B is an illustration of an example technical architecture of the user experience as a service platform 300.

FIG. 4 is an illustration of a system 400 hosting the user experience as a service platform.

FIGS. 5A to 5G illustrate an example wizard tool 500 for implementation on the user experience as a service platform.

FIG. 6 describes the process 600 for creating an example persona on the user experience as a service platform.

FIG. 7 describes the process 700 for configuring a design platform to the user's needs while addressing a business concern.

### DETAILED DESCRIPTION

Example embodiments of the present invention provide for a method, device, system, and computer program product for configuring a design platform to a user's needs for addressing a business concern; for adjusting a design platform to account for a change in one of a user's needs for addressing a business concern and a user's experience level while addressing the business concern; and for providing a streamlined design platform for a specific business concern.

To address the above described problem, embodiments of the present invention provide a flexible, extensible, and dynamically configurable architecture that provides a desirable user experience to achieve human centered design led development. A solution is described as providing user experience as a service, which empowers organizations to gain the same scale, higher quality, and reduced time to design-led human centered development. The solution uses the following described methods, systems, and devices to improve the scale, and accelerate and improve the quality of user experience innovation.

The user experience platform provides an integrated set of technologies that improves user interaction with applications, processes, content, services, and other users. The user experience platform improves the user interaction by implementing various experiences including portals, tools, content management, searches, Rich Internet Applications (RIA), analytics, collaboration, social tools, mobile tools, the Internet of Things, Augmented reality, and UX Management and Rich User Interfaces (RUI). The user experience platform improves the user interaction by supplying the user with empowerment tools, best practices design guidelines, and e-learning opportunities to scale Design Thinking (DT) learning. In an example embodiment, the user experience platform is provided as a standalone product. In another example embodiment, the user experience platform can instead be provided as a suite of products.

In part, the solution is implemented by providing interface capability having integrated platforms for: 1) Community and Collaboration, 2) Integrated Prototyping Tools, and 3) Virtual Design Up Skilling.

Community and Collaboration

Community and collaboration platforms are described herein that independently provide features of interest to users. This platform provides designers accessibility to best practice case studies from organizations that have previously completed or considered different business concerns. Moreover, this platform provides forums and discussion groups that can offer advice from peers and experts on the system regarding business concerns relevant to a designer. By accessing the platform, the designer experiences best practice collaboration. Such an environment provides low cost access to best practice knowledge. If a designer is faced with a problem that is novel in the industry, the platform further provides an environment where the designer can explore solutions to the problem with peers or explore other solutions in similar industries. Community and Collaboration are further served through the integration of a virtual marketplace on the platform, which allows for different models of the platform to subsist. In an example embodiment, the platform is provided according to a freeware model, a freemium model, and at least one subscription based model. Also on the virtual marketplace, additional controls, designs, and content are made available for sale to buyers within the community. Other well-known features linked to virtual marketplaces, such as seller and product ratings systems, are incorporated herein.

Integrated Prototyping Tools

Integrated prototyping tool platforms provide additional benefits to users on the system. The tools allow for virtual brainstorming to support ideation and synthesis. The tools included in the platform or platforms include easy to use prototyping capabilities that are accessible even for non-technical people. While using the prototyping applications, the user can create a new design from a template or begin from existing design templates and make modifications only as necessary to address the designer's specific needs. The prototyping capabilities further require design compliance to guidelines and create prototypes with sample data and back-end constraint consideration. An end product from the prototyping tool is ready for use and/or development. The tools further provide virtual end user feedback with the ability to highlight hot spots and contribute synthesized analyses. Therefore, the tools provide contextual and integrated user on-board training.

Virtual Design Up Skilling

Virtual Design Up Skilling provides: e-learning to teach an appreciation of design and human-centered development to non-designers; best practice content and templates that bring “Design Thinking” to life within an organization; and design guidelines based on best in class guidelines. The tools included allow for a user's ambition to learn a new skill and to achieve a requisite level within the new skill to drive the up skilling process. By providing design thinking content and design templates to the designers, the designs are more easily scalable and are accessible throughout different aspects of a business. The platform teaches, through various tools, skills to the designer. Concurrently, the platform is capable of evaluating the sorts of tools and methodologies that maximize the designer's response in terms of quantitative and qualitative success. By performing such evaluations of the designer's success, the platform has the optional ability to learn from the user and to apply rules from the learned behavior to assist the designer with further business concerns.

Development of the Platform in User Experience as a Service

A method implemented to provide user experience as a platform includes: querying a user for information regarding a solution category to address a business concern; configuring the platform to be consistent with the solution category provided by the user; adjusting the platform to account for changes based on at least one of a design experience level of the user, needs of the user, and factors related to the business concern.

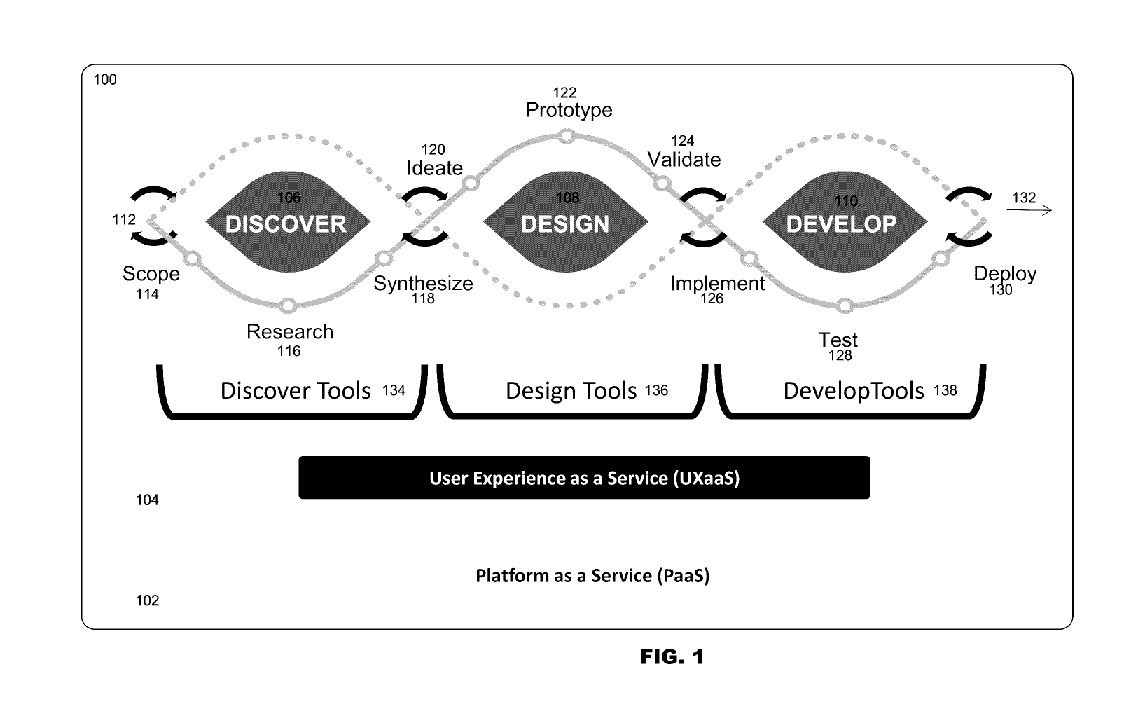

FIG. 1 is an illustration of an example tool-based approach included in the user experience as a service platform. In a traditional waterfall approach to design, a designer must, with help from others, determine the problem 112, determine the scope of the problem 114, research the solution 116, synthesize 118 and ideate 120 the solution, build a prototype 122, validate 124 the prototype, implement 126 the prototype, test the prototype 128 and deploy 130 the solution to address the business concern 132.

Instead of following the traditional waterfall approach to design, the user experience as a service platform 104 addresses the design process, but allows for the design to be performed entirely by the end user and does so with a set of tools specifically made and selected to assist the end user with the design process. The system is based on a Platform as a Service (PaaS) model 102, which allows for end users to develop, run, and manage internet based applications. Similarly, the user experience as a service model is supported by the cloud and is implemented, in an example embodiment, on a public cloud service with end user software controls that include at least deployment, configuration, and storage settings. In another example embodiment the PaaS model is implemented on private cloud service in which the end user's business provides the network, servers, and storage and with end user software controls that include at least deployment, configuration, and storage settings. In another example embodiment, the PaaS model is based on a hybrid public cloud service and private cloud service. In an example embodiment, the PaaS model 102 is supported by traditional computing devices and mobile computing devices, or mobile PaaS (mPaaS). According to an example embodiment, the PaaS vendor is SAP HANA Cloud Platform, although the following description should be similarly understood to be consistent with other PaaS vendor offerings.

The user experience as a service platform 104 is a type of PaaS. Although the user experience as a service platform 104 is shown as a layer adjacent to PaaS, this should not be misinterpreted strictly as a cloud computing layer adjacent to the PaaS (e.g., Software as a Service (SaaS) or Infrastructure as a Service (IaaS)). Instead the user experience as a service platform 104 is included as part of PaaS and 104 allows for end users to design and execute design solutions on a cloud platform. In some embodiments, the execution and storage resources automatically scale to match designer demand. In some embodiments, the execution and storage resources are manually allocated. The user experience as a service platform includes at least an execution runtime environment, databases and/or other storage, web servers, and development tools. The toolset available on the user experience as a service platform 104 includes discover tools 134, design tools 136, and develop tools 138. The discover tools 134 assist with the completion of tasks relating to problem identification, scope, research, and synthesis. The design tools 136 assist with the completion of tasks relating to ideation, prototyping, and validation. The develop tools 138 assist with the completion of tasks relating to implementation, testing, and deployment.

Cloud computing compatible tool services can include in an example embodiment at least, for discover tools: Murally™ and Drive.SAP™. Cloud computing compatible tool services can include in an example embodiment at least, for design tools: BUILD™, AV™, and Drive.SAP™. Cloud computing compatible tool services can include in an example embodiment at least, for development tools: SAP Web Integrated Development Environment (IDE)™. Other cloud computing compatible tool services implemented on the user experience as a service platform 104 include in an example embodiment any of: mooc.house™, Design 99™, SAP DT Playbook™, Design & Co-Innovation Center™ tools, SAP Fiori Design Guidelines, and the SAP Fiori Applications Reference Library.

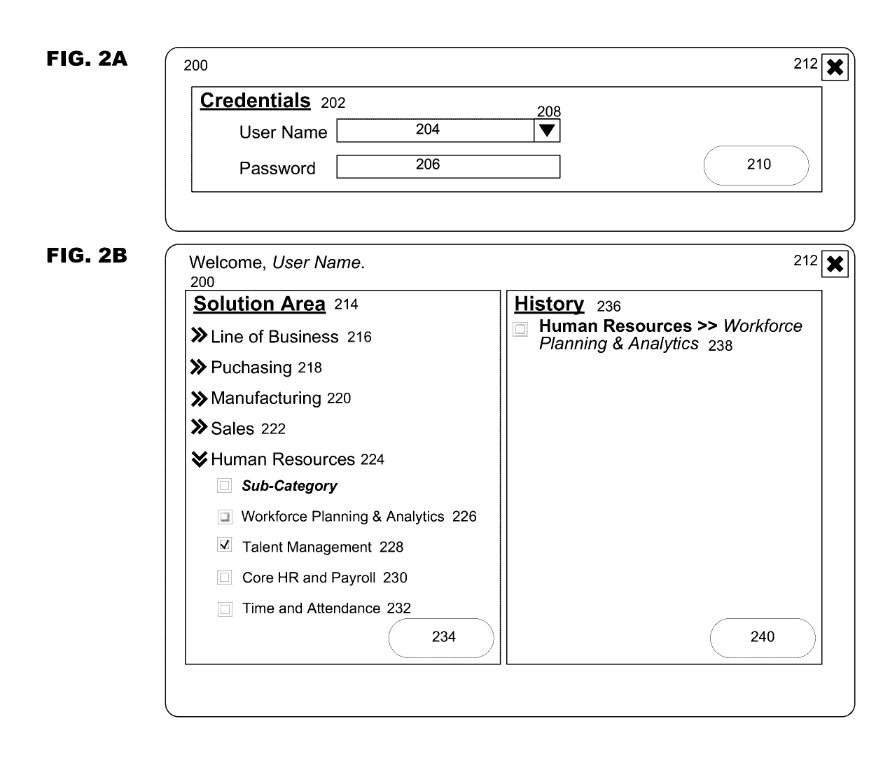

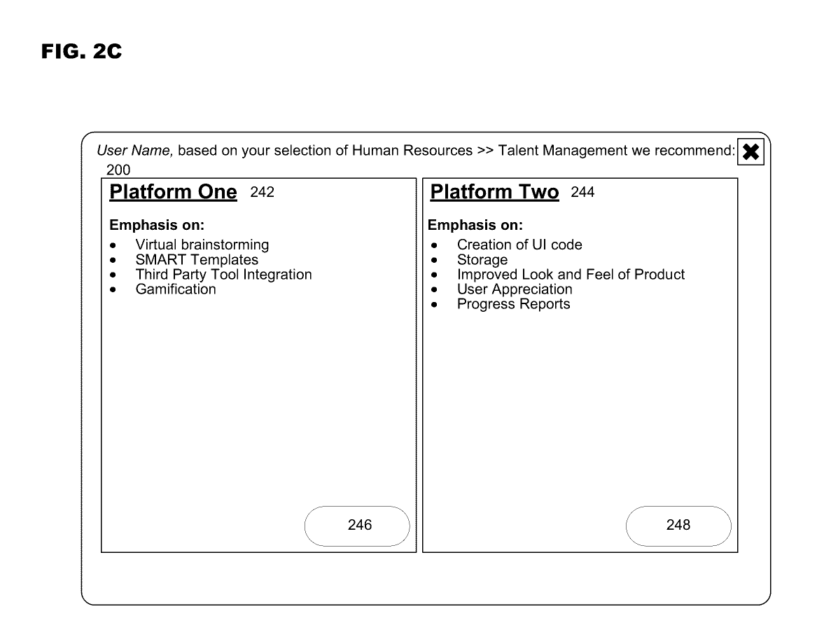

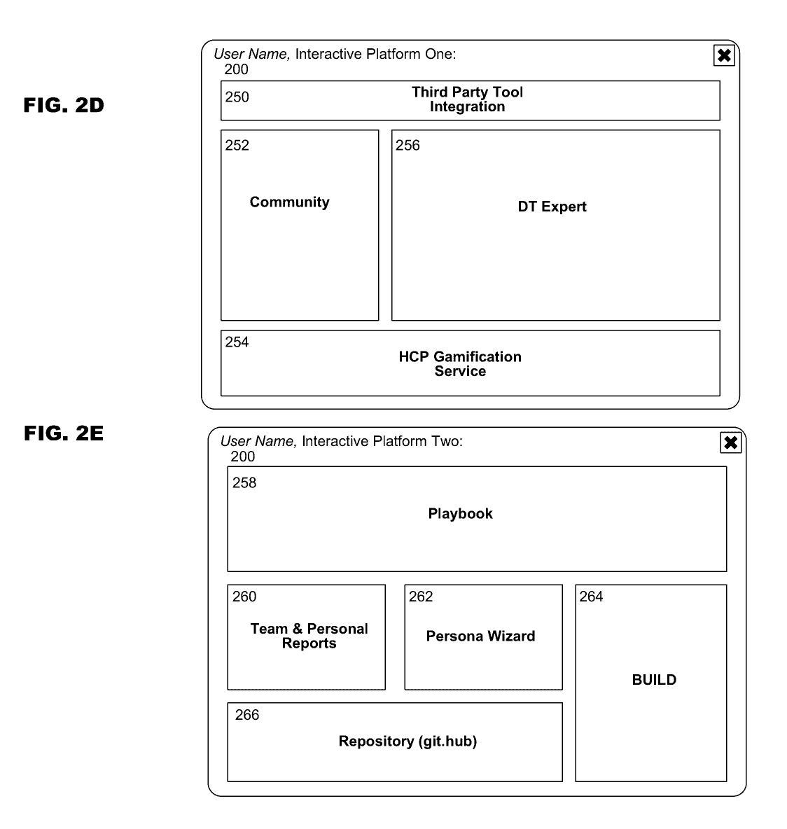

FIG. 2A is an illustration of an example user interface portal 200 to access the user experience as a service platform. To enter the user experience as a service platform, a user must provide a set of credentials 202, which can include any number of fields. The fields accept input from the end user, and transmit the accepted input to a backend server to verify that the supplied credentials match credentials that have access to the user experience as a service platform. As an example embodiment, the user provides text input of a User Name into a field 204 and text input of a Password associated with the User Name into a field 206. In an example embodiment, the User Name can be saved and selected by clicking on a drop down portion 208 of field 204. The drop down portion 208 indicates recently used or saved user names from which the user can select a relevant User Name. After having entered the necessary credentials, the user can select enter on a keyboard to submit the credentials for verification. In another example embodiment, the user can select 210, which is representative of one of a Begin, Start, Log-In, or Proceed key to submit the credentials for verification. By selecting Exit button 212, the user can exit the user interface portal.

FIG. 2B is an illustration of the example user interface portal 200 to customize the user experience as a service platform. Within 200, the credentials 202 of the user are displayed to provide the user with a greeting to the user interface portal 200, which notifies the user that the authentication of credentials has successfully been completed. To customize the user experience as a service platform, a user must provide information regarding the solution area (or solution areas) that address the user's business concern. The user interface portal 200 presents the user with solution areas 214 such that the user can select the solution area relevant to the user's business concern. In an example embodiment, each solution area has an associated description such that a user can understand the context of the solution area well enough to make a selection. The associated description is provided by text proximate to the solution area heading. In an example embodiment, the associated description is provided when the user clicks on the solution area heading or as a pop out text box when the user hovers a cursor over the solution area. In user interface portal 200, solution areas 214 include: “Line of Business” 216, “Purchasing” 218, “Manufacturing” 220, “Sales” 222, and “Human Resources” 224. Other solution areas, which address a business concern but which are not explicitly referred to are considered incorporated herein.

Each solution area further provides sub-categories for more detailed solution area exploration. For example, solution area “Human Resources” 224 includes example sub-categories such as “Workforce Planning & Analytics” 226, “Talent Management” 228, “Core HR and Payroll” 230, and “Time and Attendance” 232. As with the solution categories, an associated description is provided for each of the sub-categories when the user clicks on the sub-category heading or as a pop out text box when the user hovers a cursor over the sub-category heading. In an example embodiment, several category layers are expanded out, allowing for maximum visibility of the different solutions and their relative relationships.

In some example embodiments, the solution areas are provided to the user in a visualization, such as a solution area tree. To select a sub-category, a user clicks a checkbox associated with the subcategory. A user can select multiple sub-categories. In another example embodiment, the sub-categories are hyperlinks and automatically accept, upon clicking of the hyperlink, the hyperlink as the input and generates a next user interface portal. The checkboxes associated with the sub-categories can further be initially presented with default values (e.g., checkbox 226). After having entered the necessary solution areas, the user can select enter on a keyboard to submit the selected solution areas in order to generate the next user interface portal page. In another example embodiment, the user can select 234, which is representative of one of a Begin, Start, or Proceed key to submit the selected solution areas. By selecting Exit button 212, the user can exit the user interface portal.

The user interface portal 200 further includes a pane (or a section) 236 containing historical information regarding the user's previous solution areas of interest. For example, the history pane 236 includes a detail “Human Resources>>Workforce Planning & Analytics” 238 which indicates that the user has, in a previous session or earlier in a current session of the platform, selected Human Resources as a solution area of interest and Workforce Panning & Analytics as a sub-category of interest. By providing a selection option next to 238, the user can quickly review previous solution areas of interest in order to expedite the transition to the relevant user interface portal page. After having entered the necessary historical information, the user can select enter on a keyboard to submit the historical information. In another example embodiment, the user can select 240, which is representative of one of a Begin, Start, or Proceed key to submit the selected historical information. By selecting Exit button 212, the user can exit the user interface portal.

Following entry of the solution areas of interest in FIG. 2B, the user experience as a service platform is displayed to the designer as an array of design content, design samples, and design tools all relating to the selected solution area of interest. The design samples provide the designer with an ideal end state for the solution area of interest application. The design content, design samples, and design tools provide foundational information and prescriptive tasks that enable the designer to reach the demonstrated ideal end state. In an example embodiment, multiple possible ideal end states are revealed to the designer after the selection of the solution area of interest. Then, the designer selects the preferred ideal end state, and the design content, design samples, and design tools are tailored to assisting the designer meet the selected preferred ideal end state.

For example, as shown in FIG. 2B, the designer indicated that Human Resources>>Workforce Planning & Analytics was the solution area of interest. Accordingly, the display to the designer includes a plurality of design options. In an example embodiment, the display to the designer includes: 1) a design program to analyze the amount of natural attrition from the workforce and 2) a design program to determine the number of new hires needed to maintain the total number of employees in each business department. The designer can select either the first option (natural attrition design) or the second option (number of new hires). Based on the designer selection, the user experience as a service platform determines which of the underlying design content, design samples, and design tools are displayed to the designer. Furthermore, in some example embodiments, the user experience as a service platform determines the order in which the designer should complete a review of the design content and design samples, and/or should access the design tools in view of the designer's selection of the first or second option.

FIG. 2C is an illustration of the example user interface portal 200 to account for initial user input regarding the user experience as a service platform. After selection of the solution areas and sub-categories of interest, the platform can be further configured to present different initial platform options to the designer. In an example embodiment, the designer is provided with several options, such as Platform One 242 and Platform Two 242. The designer is further provided with additional information regarding the distinctions between the platforms. For example, Platform One is indicated as desirable for designers having an emphasis on Virtual Brainstorming, SMART Templates, Third Party Tool Integration, and Gamification. To select Platform One, the designer clicks on button 246. Platform Two is indicated as desirable for designers having an emphasis on Creation of UI code, Storage, Improving the look and feel of a product, User Appreciation, and Progress Reports. To select Platform Two, the designer clicks on button 248. Similar selection mechanisms to determine features that are important to a designer can be used in an alternative approach to the one presented in FIG. 2C. In an example embodiment, the designer does not actually select the platform configuration but the designer's preferences are used to generate an inherent selection and organization of the platform. Despite initial presentation of the platform, however, all features of the platform are available for the designer and the designer can at any time indicate a change in desired content, applications, and organization of the platform by interacting with the platform.

FIG. 2D is an illustration of the example rich user interface 200 of the platform according to one example configuration. FIG. 2D provides the resultant user interface portal 200 if the designer selected button 246. Based on the emphases indicated as desirable by the designer, the platform provides easy and targeted access to: Third Party Tools 250; Community 252; DT Expert 256; and Gamification Services 254.

FIG. 2E is an illustration of the example rich user interface 200 of the platform according to an example configuration different than the configuration presented in FIG. 2D. FIG. 2E provides the resultant user interface portal 200 if the designer selected button 248. Based on the emphases indicated as desirable by the designer, the platform provides easy and targeted access to: the Playbook 258; Team and Personal Reports 260; the Persona Wizard 262; BUILD 264; and storage repositories 266. A storage repository, such as GIT.hub can be implemented on user experience as a service platform.

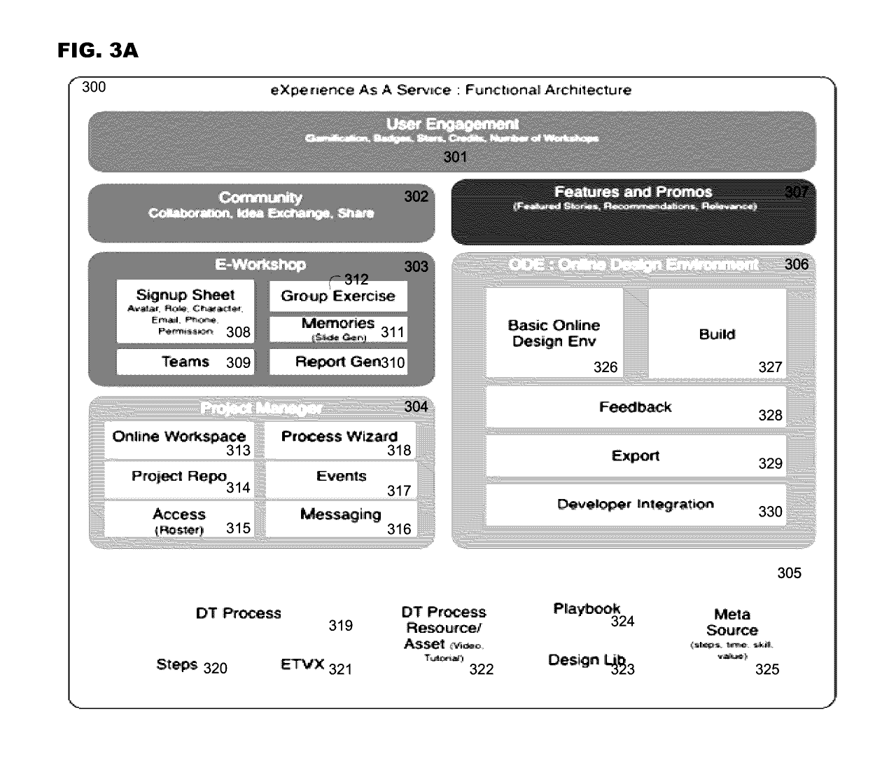

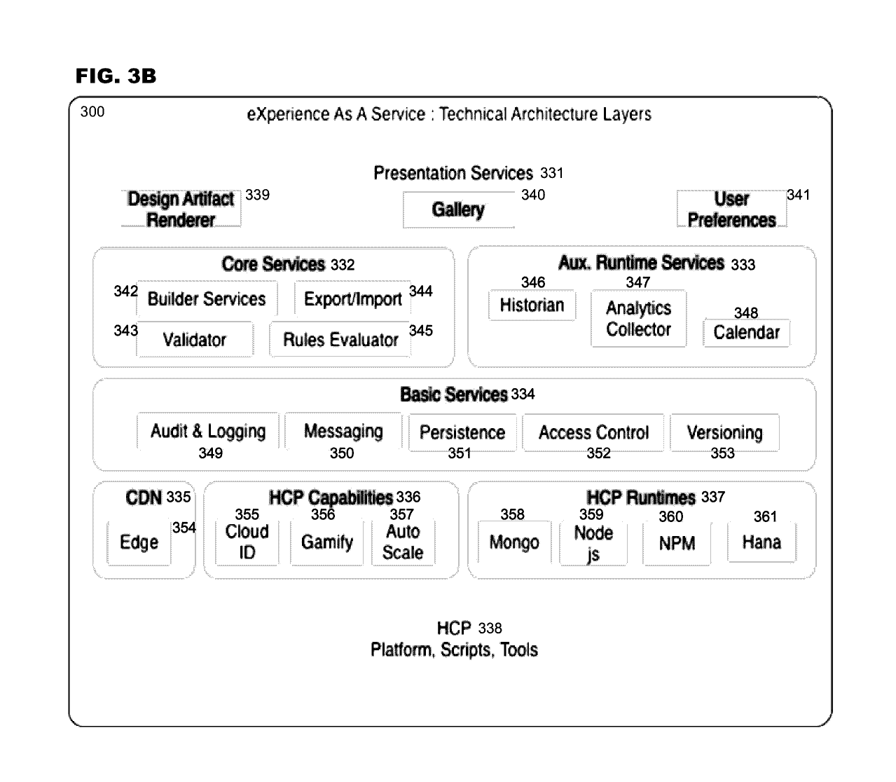

FIG. 3A is an illustration of an example functional architecture of the user experience as a service platform 300. The user experience as a service platform 300 provides a plurality of different functionalities. Generally, the platform has the capability to provide functionality directed at least to: User Engagement 301, Community 302, E-Workshop 303, Project Manager 304, DT Expert 305, Online Design Environment (ODE) 306, and Features and Promotions 307. The functionalities described herein are not mutually exclusive. At any point in time, the user experience as a service platform operates to provide at least one, if not all, of the above-described functionalities. Often a plurality, or all, of the functionalities are integrated into each module of the platform used by the end user.

The user experience as a service platform 300 provides User Engagement 301. Different tasks and programs made available to the designer are provided to engage the designer. In one example embodiment, the end designer is engaged by the platform due to integration of gamification techniques. An end designer, in an example embodiment, competes against other end users on a same team or on a different team to achieve a goal. In another example embodiment, end users are rewarded, with badges, for each achievement earned on the platform. If the end designer completes viewing an e-workshop video, a badge is presented to the end designer. In some example embodiments, badges are displayed to other end users so that the other end users can appreciate the achievements of colleagues or understand the extent to which another end user is knowledgeable in a specific area.

In another example embodiment, designer engagement is encouraged with credits. Similar to badges, credits are awarded to a designer upon a credit-earning activity. A credit earning activity can be completion of a design task, providing expertise to another designer through a community idea exchange, and so one. Upon accumulation of a sufficient number of credits, a designer can spend credits on a prize that is or is not associated with the design process. For example, credits can be expended by the designer on a physical good for the designer's personal use. In another example embodiment, credits can be expended to facilitate design. For example, credits can be expended to unlock desirable “Plays” from the Design Thinking Playbook that are otherwise available at an additional fee. Credits may also be referred to as points or rewards.

Furthermore, user engagement is encouraged by provided a multiplicity of workshops related to all facets of design that are of interest to an end user on the platform. Specifically labeled and diverse offerings in workshops can further encourage an end user to explore the platform and develop his or her credentials and expertise. In addition to credits and badges, user engagement is further encouraged on the platform through implementation of ranking in solution areas and/or teams, providing grades to designers based on their individual or team artifacts, evaluations from moderators, team leaders, or third parties, and scoring of individuals and teams based on submitted assignments. Artifacts include UI elements, application logic, and any other advances attributable to design lifecycle management. Generation of artifacts is initially performed with low-fidelity. Following iteration and designer advances, the artifacts are generated with high-fidelity and include detail levels of particular value in providing a design solution, such as complete HTML5.

The user experience as a service platform 300 provides Community 302. Different tasks, programs, and means for communication are provided in a manner to promote conversation directed to design. In some embodiments chat rooms are provided for exchanging ideas related to projects and solution area. In an example embodiment, the user experience as a service platform provides environments such as chat rooms and interactive team environments to encourage collaboration among members of the same design team or among those working on similar sorts of projects. In an example embodiment, the user experience as a platform provides environments such that designers can share past, ongoing, and future project ideas, artifacts, and models. Designers can upload full or redacted version of artifacts, such as documentation, to encourage conversation and collaboration, and further to encourage a faster design model in which designers assist one another with projects to reduce design timelines. The Community facilitates virtual brainstorming sessions, follow-the-sun work, and dynamic discovery sessions.

The user experience as a service platform 300 provides E-Workshop 303. E-Workshop 303 includes Signup Sheet 308, Teams 309, Report Generation 310, Memories 311, and Group Exercise 312. In order to participate and track designers in E-Workshops, designers register using Signup Sheet 308 or similar registration techniques. In so doing, a designer creates an avatar representative of the designer and establishes a role in the E-Workshop community. The designer can, according to personal preference, provide or link communications from the E-workshop environment or from other designers in the E-Workshops for which the designer is registered to the designer's personal or work email, or the designer's phone. The designer further can establish permissions related to the extent to which other users can access work product generated through the E-Workshops, or the extent to which other users can track the designer's progress through the E-Workshops.

The designer can sign up for E-Workshops as a sole designer or as part of a Team(s) 309. The designers can engage in collaborative learning and facilitate an ongoing dialogue related to the information consumed in the E-Workshop. The sole designer or teams can further register to participate, through E-Workshops in Group Exercises 312. While engaged in a Group Exercise, a task that is submitted by a moderator of the E-Workshop, or a real business concern, can be addressed by the Team. If a sole designer registers for a Group Exercise, then the sole designer can be incorporated into a group of other sole designers or the user can be added to a group containing at least one Team, if all of the designers' permissions allow. In order to catalog progress through E-Workshops and to facilitate comprehension, Memories 311 and Report Generation 310 are integrated into the E-Workshop process. Reports generated can be directed to a sole designer, a Team, or a sole designer within a Team. Reports can provide relative success of designers within a team and their contributions towards the team goal.

The user experience as a service platform 300 provides Project Manager 304. In order to adequately provide an environment that facilitates teamwork and generation of artifacts, projects are capable of being controlled. Projects can be managed through manipulation of online workspaces 313, project reports 314, access limitations 315, messaging 316, events 317, and process wizards 318.

Online workspaces 313 can be created for individual projects and/or teams. An online workspace is available for management and review by a designated leader of the project and/or team. In an example embodiment, a moderator is selected in the absence of a leader. A moderator can be a member of the team or a third party that is unaffiliated with the team but that has access to the team environments. Similar to the above described report generation, project reports 314 are available. A project report can be made available to a team leader, all members of a team, or restricted members of a team. The project report can assess the project status, the contributions of team members, the tools used by team members, and adherence to a timeline. Project reports can quantitatively evaluate the success of a project, and qualitative success of a project can further be assessed through leader evaluation or third party analysis of the project.

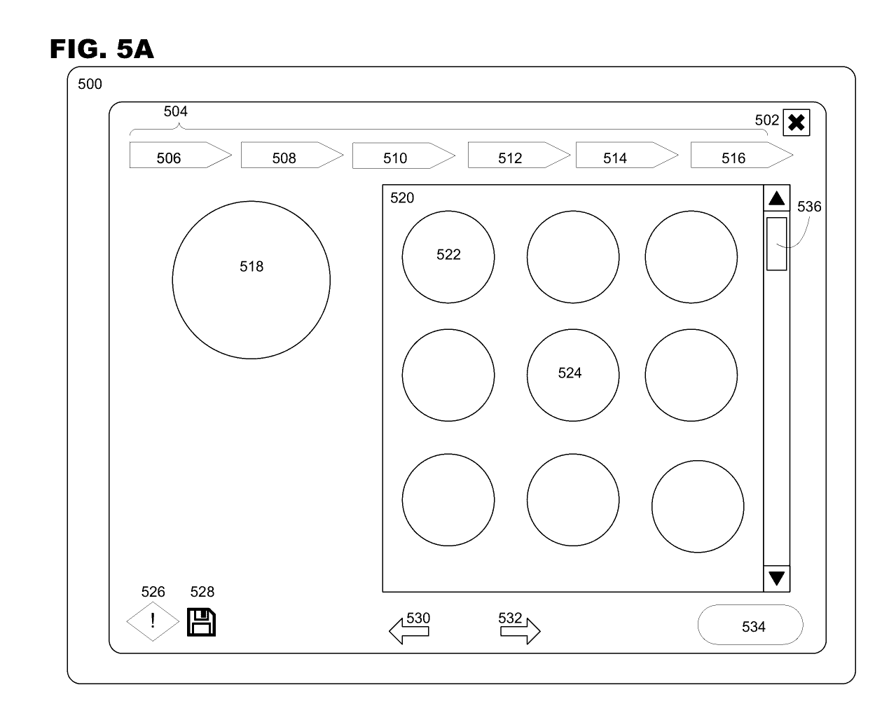

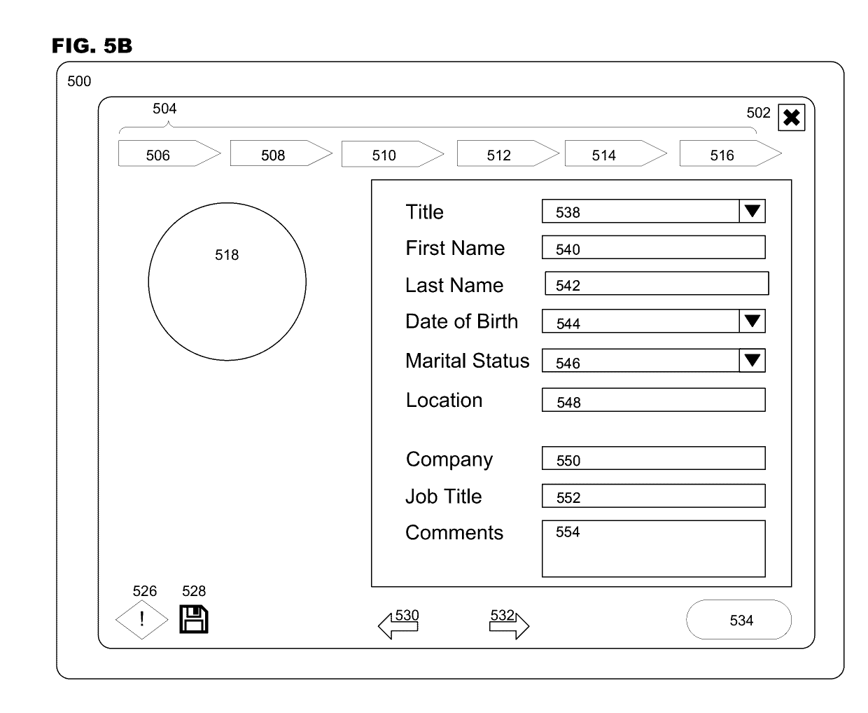

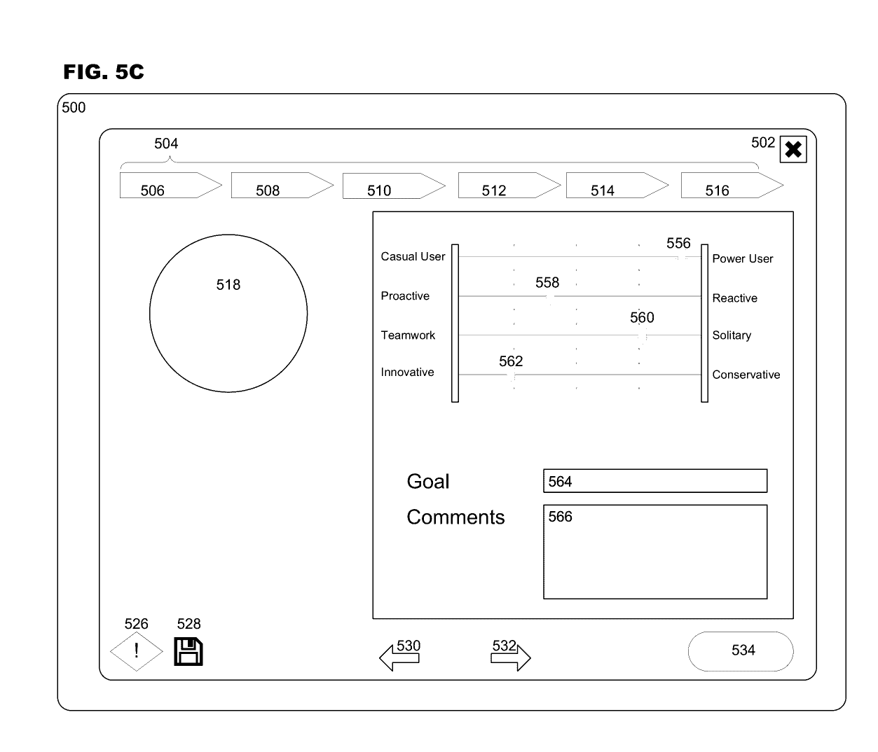

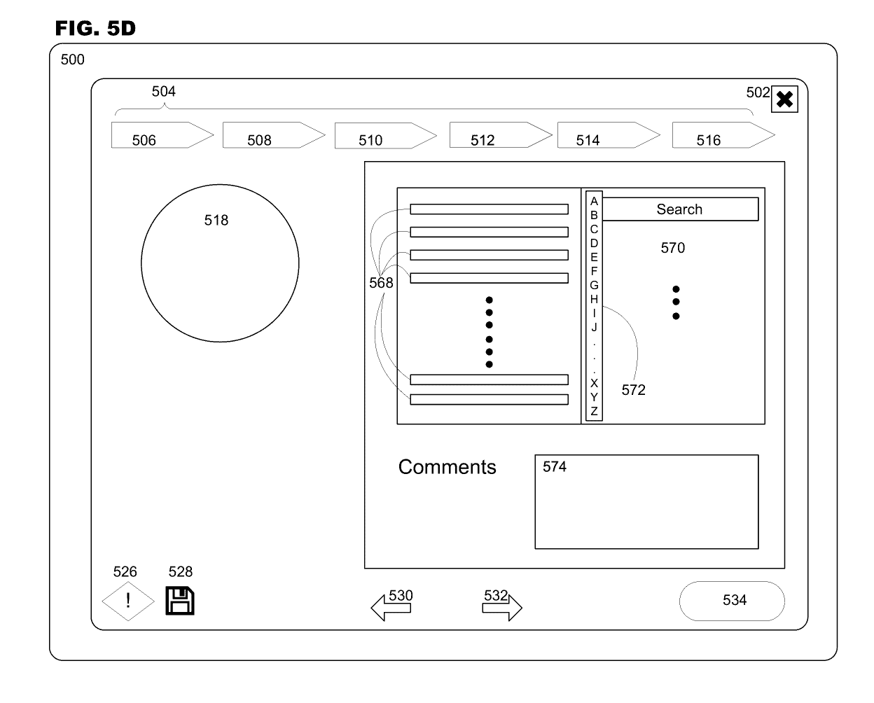

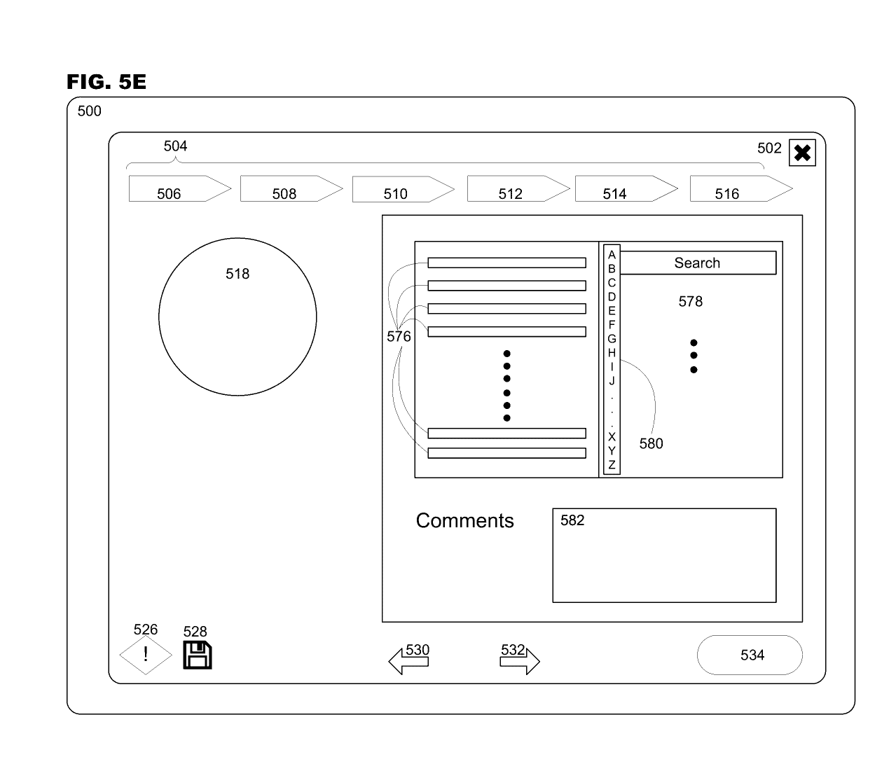

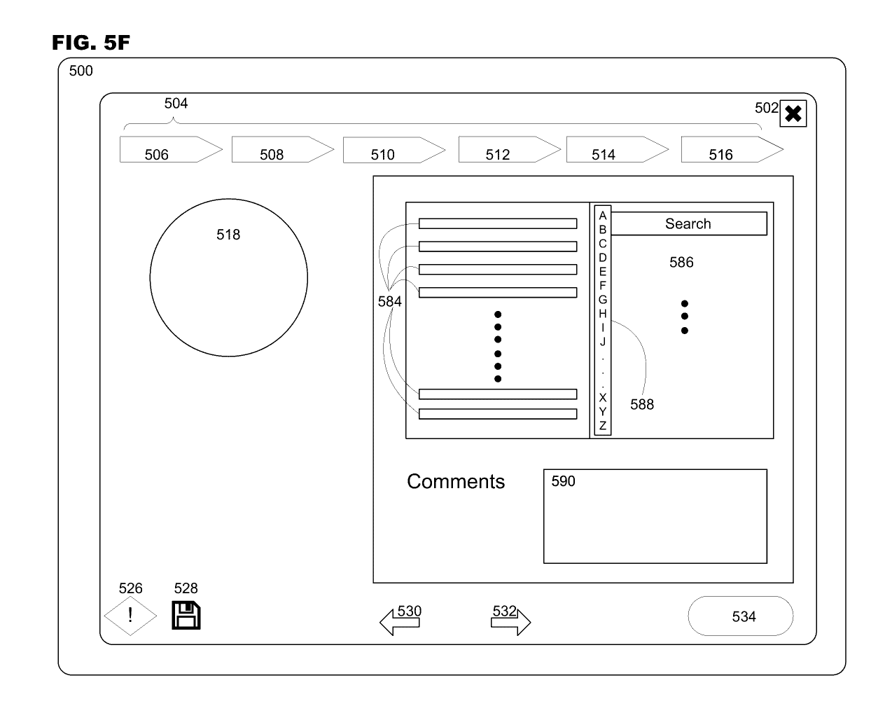

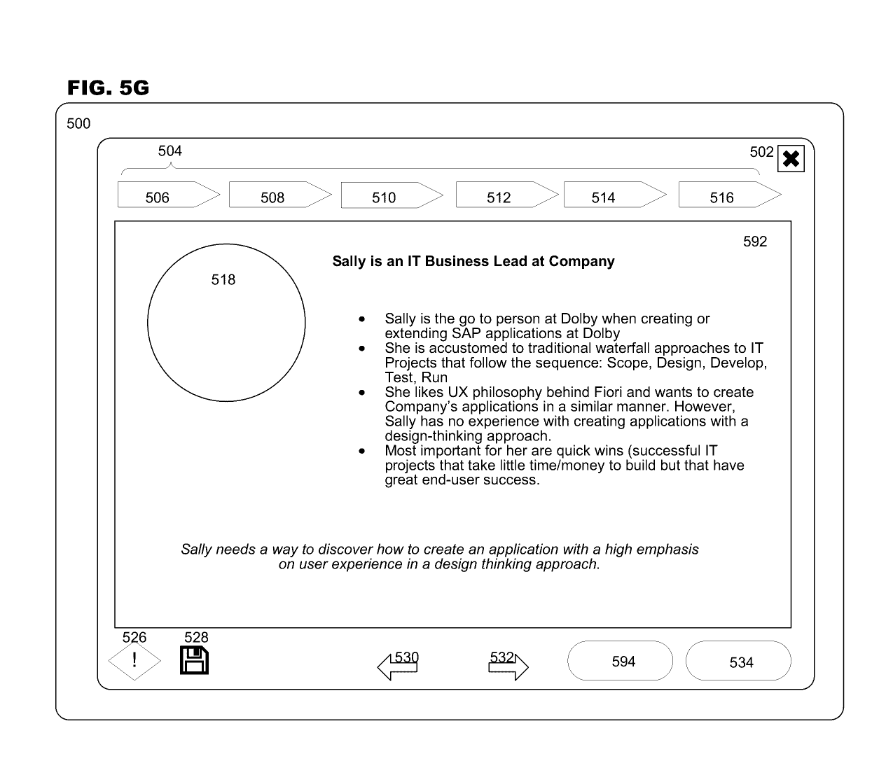

Project management is facilitated by the ability to restrict access 315 to the project to certain usernames or employees. For example, access can be restricted according to a roster of employee names and/or usernames. Moreover, project access can be structured such that different team members can only provide solutions to different parts of a project. Communications among team members or those working on a same project are bolstered by messaging techniques 316. The project management further includes events 317. Events 317 can be managed and reported to team members via calendar alerts, countdowns, and notifications to all or some of the team working on particular projects. Events can further include designation of assignments to team members or a subset of team members. In addition, for project related tasks that are new or unfamiliar to team members, supervision and guidance is facilitated by process wizards 318 (such as the wizard described below with reference to FIG. 5). Process wizards can provide step by step instruction to a design process (such as Persona Creation) so that designers can focus on the design and sharing a design as opposed to direct and immediate supervision for new tasks.

The user experience as a service platform 300 provides Design Thinking (DT) Expert 305. DT Expert 305 includes DT Process 319, Steps 320, Entry, Task, Verification, and Exit (ETVX) 321, DT Process Resource Asset (Video, Tutorial) 322, Design Library 323, Playbook 324, Meta Source 325.

To encourage design thinking and to foster development of DT skills, the user experience as a service platform includes expert design thinking information to share with designers on the platform. In particular, the DT Expert includes documentation and support to describe the process 319 of design thinking to the designer. In so doing, the DT Expert utilizes a step by step approach 320. In order to address the appropriate portion of the process of design thinking that is relevant to the designer, the platform evaluates what steps are necessary for the specific process of interest to the designer.

In order to appropriately enter the relevant steps, DT Expert provides a model view of ETVX 321. The ETVX includes information regarding inputs or triggers that initiate an entry point into the DT process. ETVX further includes information regarding the controls and constraints that should be factored into the DT Process and regarding the validation of the tasks. Once the exit criteria established by the ETVX are established, herein a design artifact or output, during validation, the task is ended and the DT process is exited. In order to provide assistance resources during the DT Process, Resources and Assets 322 are available. The Resources and Asserts include videos and tutorials. The videos and tutorials can be lesson plans, and the resources may be triggered, or trigger, upon the availability of a next DT Process.

The DT Expert further includes a Playbook 324. In an example embodiment, the Playbook is the SAP Design Thinking Playbook. A playbook includes proven methods for design development and may include examples for different design challenges, best practices, case studies, and guidelines. DT Expert further includes a Design Library 323, for designers needing a more technical explanation, templates and floorplans addressing various design challenges. Such templates and floorplans can be adapted by a designer for personal use and implementation, particularly when used in combination with the Resources/Assets. The DT Expert also provides Meta Source 325. Meta Source includes information regarding steps that reduce the time and skill needed to complete a task and increase the value of even a less knowledgeable designer and that designer's artifacts.

The user experience as a service platform 300 provides Online Design Environment (ODE) 306. The ODE includes the functionality of Basic Online Design Environments 326, Build Environments 327, Feedback 328, Export 329, and Developer Integration 330. One goal of the user experience as a service platform is to generate actual designs in addition to any reusable artifacts that are generated in the process. As such, the platform provides a basic online design environment 326. The Basic ODE is available without downloading or saving any particular elements necessary for the environment because the environment is supported by the cloud. Similarly, the ODE automatically includes the capabilities to support a design build 327 environment. When prototyping, the Core Services can further include a link to catalogs, such as those available from external services like FIORI, that allows designers to browse and import external applications for prototyping and integration into user research scenarios. In order to encourage users to proceed with their design projects and to counter roadblocks, feedback 328 regarding ongoing or completed designs is available in real-time or through messaging platforms. Feedback can be provided in forums, discussion groups, posting areas, or through grading systems where grades are distributed from other users, leaders, or moderators. Once a designer or a team is satisfied with a design product, the design and the associated source and executable files can be exported 329 through the ODE. Integration of different designs is further facilitated through developer integration 330, which is available through the ODE. Projects from different users or different teams can be quickly integrated and adjusted for integration on a platform with high visibility so that comments and feedback can be provided promptly.

The user experience as a service platform 300 provides Features and Promos 307. A features and promotions function is incorporated into the user experience as a service platform to provide context and relevance to designers using, or interested in using, the platform. As capabilities supported by the platform expand, new features and new concepts are introduced with high visibility. The user experience as a service platform is capable of seamlessly incorporating any such new feature because the platform can incorporate any commercial off the shelf (COTS) component or custom component supported by a cloud computing network. The features can further provide ideas to designers relating to new or pending design projects. The features section can, in addition to providing stories regarding other designers, provide specific and tailored exploration recommendations to the designer based on the designer's personal usage of the platform. For example, if the designer's history in an example embodiment indicates that the designer has comfort with a particular design process the features functionality recommends to the designer that the designer take on an expert role in the community. In addition, the features functionality further recommends that the designer learn a new design process that is more efficient than a process that a designer has used on several occasions.

FIG. 3B is an illustration of an example technical architecture of the user experience as a service platform 300. In order to provide the diverse functionality of the user experience as a service platform 300, the following technical specification should be provided. Specific descriptions of runtimes, capabilities, platforms, scripts, and tools with reference to names should be understood as representative examples only, and these representative examples should extend to all similar environments and technical elements as would be understood by one of ordinary skill in the art. Generally, the platform includes the technical components such as: Presentation Services 331, Core Services 332, Auxiliary Runtime Services 333, Basic Services 334, Content Delivery Network (CDN) 335, Cloud Capabilities 336, Cloud Runtimes 337, and Cloud Platform, Scripts, and Tools 338. As an example, and as shown in FIG. 3B, the cloud is generally referred to as the HANA Cloud Platform (HCP), but as a representative example only. The technical architecture layers described herein are not utilized in a mutually exclusive manner. At any point in time, the user experience as a service platform operates to provide functionality by relying on multiple architecture layers.

The user experience as a service platform 300 includes technical architecture layer Presentation Services 331. In an example embodiment, Presentation Services include at least one of: Design Artifact Renderer 339, Gallery 340, and User Preferences 341. In order to provide a designer with the tailored images and artifacts specific to the user, such presentation services are necessary. In an example embodiment, a 3-dimensional object has been designed as part of a design solution. In order to present the 3-dimensional design to the designer for consideration, a Design Artifact Renderer 339 must be implemented. The Design Artifact Renderer interfaces with the other packages, including for example BUILD, to import and instantiate design thinking artifact packages into BUILD projects. Artifacts that the platform supports importing and instantiating in build development/design applications include at least interaction design templates such as personas, point of view analysis, and story boards. To provide supporting images and reference information, Gallery 340 is accessed. User Preferences 341 adjust the artifacts available for the designer to review and consider.

The user experience as a service platform 300 further includes technical architecture layer Core Services 332. Core Services 332 provide build automation support for completing tasks relating to binary code packing, compiling source code, and preparing design system deployments. The Core Services 332 include Builder Services 342, export/import features 344, validator 343, and rules evaluator 345. Builder Services access build scripts and automate calls to compilers and linkers to complete the automation process. Export/import features 344 are used to import or export necessary build files. Rules Evaluator 345 evaluates rules within the build script individually and executes the rules, in an order of priority, according to the action associated with the rule. In order to validate a build, or a proper evaluation of the rules associated with the build, Validator 343 is implemented.

The user experience as a service platform 300 includes technical architecture layer Auxiliary Runtime Services 333. Auxiliary Runtime Services includes: Historian 346, Analytics Collector 347, and Calendar 348. The Auxiliary Runtime Services continually track behavior on the platform and the platform response. Historian 346 analyzes the platform response and the significant responses from the platform. Analytics Collector 347 records in an associated database information regarding design builds and usage of the platform. Calendar 348 provides necessary tracking of date and time information to keep data records and processes up to date and on track.

The user experience as a service platform 300 includes technical architecture layer Basic Services 334. Technical execution is performed to maintain processes related to Auditing & Logging 349, Messaging 350, Persistence 351, Access Control 352, and Versioning 353. Versioning 353 is implemented on the platform such that version control is maintained and designers can learn without jeopardizing personal or team progress. Similarly, versioning provides check in and check out options, as well as rollback options for designers.

Third party applications, such as GIT can further be integrated into the user experience as a service platform. For example, integration with GIThub can be used to commit and clone a BUILD snapshot to a GIT implementation in GIThub. The snapshot can thereafter be included in the generate repository that is compatible with the Web IDE. The designer can then create Web IDE projects by developing a pointer to, in a new workshop, the repository including the snapshot.

The user experience as a service platform 300 further includes technical architecture layer CDN 335. CDN 335 includes a system of distributed servers (network) that deliver webpages and other web content to a user based on the geographical locations and that track the geographical proximity of a user relative to an origin location. By accounting for the relative locations between the edges, which are tracked by Edge 354, geographical proximity is used as a factor in accelerating delivery of media and other services.

The user experience as a service platform 300 includes technical architecture layer Cloud Capabilities 336. Cloud Capabilities 336 further include Cloud ID 355, Gamification 356, and Auto Scaling 357. Cloud ID 355 is implemented to authenticate and identify users according to either an internal database or a database owned and operated by an external business. Accordingly, authentication is provided based on a trust configuration and the Cloud ID. In some example embodiments, the user experience as a service platform integrates the authentication process with backend systems for users of third party platforms. Default behavior is provided to propagate the current user credentials, including username and password, to the external service and rely on the SSO based authentication mechanism to authenticate and authorize the user. In another example embodiment, an administrator of the user experience as a service platform configures the connections with the platform such that the third party credentials are used to gain access to the platform.

Gamification 356 allows for rapid introduction of gamification concepts into applications. As an example, gamification includes online development and administrative environments. Gamification monitors each of time constraints, complex nested missions, and collaborative games. In an example embodiment, the gamification is the HCP Gamification Service on the SAP HANA Cloud. Auto Scale 357 provides scaling features and continually updates secondary systems according to a directive from a primary system. In an example embodiment, automatic scaling is implemented to overcome system faults and failures on the platform.

The user experience as a service platform 300 includes technical architecture layer Cloud Runtimes 337. In an example embodiment, the supported runtimes include Mongo 358, Node js 359, NPM 360, and Hana 361. In the example embodiment, the supported runtimes support field, range, and expression searches, as well as indexing. The supported runtimes further allow designers to view, update, and remove data in databases through web interfaces. In another example embodiment, the supported runtimes cover server side and networking applications and maintain an event driven architecture. The supported runtimes allow for creation and distribution of web servers and networking tools. In an example embodiment, the supported runtimes allow for publication and sharing of libraries among a community, which simplifies installations and updating of libraries. Similar runtimes should be considered incorporated herein. The user experience as a service platform 300 includes HCP Platform, Scripts, and Tools 338 compatible with the runtimes. Tools and components implemented can include any combination of native applications, web applications, and hybrid applications. Data sources supporting the platform include back-end servers, spreadsheets, text files, and other similar files. The platform can automatically construct access services through usage of markup languages, such as XML, application programming interfaces (APIs), such as RESTful, and data access protocol, such as oData.

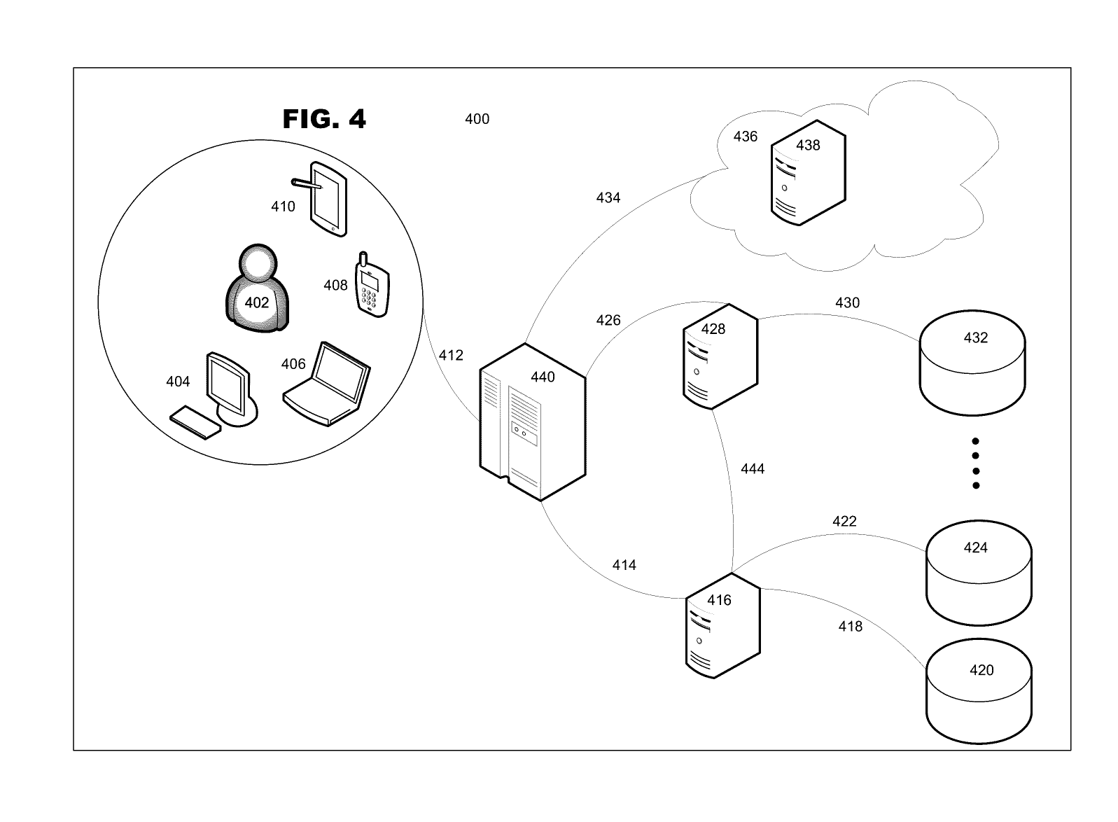

FIG. 4 is an illustration of a system hosting the user experience as a service platform 400. The user 402 accesses the user experience as a service platform using at least one of his devices (networked client devices): computer 404, laptop 406, smart cellular telephone 408, and tablet 410. Communication link 412 connects the utilized device (i.e., 404, 406, 408, and 410) to a point of access server 440. Point of access server 440 is connected to a collection of additional deployed remote servers and software networks. The networks of servers provide data storage and computational services when requested by the devices. Some of the servers in the network of servers are allocated to provide specialized storage (e.g., the servers associated with databases 420, 424, 432), and some of the servers in the network of servers are allocated to provide computation power (e.g., 438) and run web based applications.

Web based applications are supported by the specialized storage and computation power provided by the cloud and are accessed by the user through a web browser available on the device of user 402. The network of servers displayed (i.e., any of 440, 438, 428, and 416) are part of the cloud. Server 438 is shown as within cloud 436 to further indicate that the user 402 accesses the user experience as a service platform through any of a public cloud (e.g., 440, 428, 416) a private cloud (e.g., 436) or a hybrid of public and private cloud sources. Communication links 412, 434, 426, 444, and 414 are generally wireless communication links. Communication links 430, 422, and 418 are generally wired communication links. In an example embodiment, the user experience as a service platform is available over a web browser. In another example embodiment, the user experience as a service platform is available only over specific client software, such as a virtual desktop.

FIGS. 5A to 5G illustrate an example wizard tool 500 for implementation on the user experience as a service platform. Although the example described below includes information with regard to design of a persona tool, the same organization and presentation on the platform can be used to further render different design artifacts such as story boards, use cases, and point of view analysis. The persona creation tool 500 is implemented to assist a designer in creating a target persona. A target persona refers to an ideal description of the typical end user of a particular product. Instead of a representative of the ideal end user class completing a survey provided by the designer and describing the end user's needs, the designer can create the persona using the interactive tool 500 to determine the same information. Persona creation tool 500 is presented to the designer in a portal or as part of a graphical user interface (GUI). Within the interface, the persona creation tool includes a navigation bar 504 displaying the relative progress towards completion of persona creation process.

FIG. 5A depicts a display during a stage of use of the persona creation tool 500. FIG. 5A depicts a stage 506 in the navigation bar 504. In an example embodiment, stage 506 is labeled accordingly as, for example, “Person.” In some embodiments, each stage includes a directive text statement notifying the designer how to perform the necessary action to advance to the following stage. For example, in the first stage 506 for “Person,” such a directive could state “Select your photograph” or “Identify, with a picture and a name, the Persona.” First stage 506 includes a display section 518. Display section 518 updates to provide a selected picture representative of the Persona and a selected name of representative of the Persona. In interactive section 520, multiple options (such as 522 and 524) are provided for selection as the picture representative of the Persona. Upon selection of one of the pictures in interactive section 520, the Display section 518 is updated accordingly to present the selected picture. The options provided in the Interactive Section can be navigated by a designer and may involve manipulation of a slider bar 536 to see more options. After the designer is satisfied with the selection of the information in the display section 518, the user can proceed to the next section by selecting proceed-forward button 532. To exit the persona creation tool, the designer can select the proceed-backwards button 530 or the exit button 502. At any point, if the designer wants to generate the persona based on the currently supplied information, the designer selects button 534.

FIG. 5B depicts a display during a stage of use of the persona creation tool 500. FIG. 5B depicts a stage 508 in the navigation bar 504. In an example embodiment, stage 508 is labeled accordingly as, for example, “Profile.” In some embodiments, a directive text statement associated with stage 508 states “Enter your Profile.” Stage 508 includes a display section 518 that includes at least the selected picture from stage 506. Stage 508 further includes an interactive section having at least fields 538 to 554. Fields 538 to 554 include fields pertinent to disclosure of the profile of the target persona. For example, the fields include personal information (e.g., fields 538 to 548) and work information (e.g., fields 550 to 554). Additional fields related to personal information and/or work information should be considered disclosed herein. Furthermore, additional information for the profile could be collected at this time including: education level (e.g., high school, GED, bachelor's degree, advanced degree, etc.), family information (e.g., number of family members, age of youngest family member, age of oldest family member, identification of primary breadwinner, identification of primary household consumer), and technology expertise (e.g., beginner, intermediate, advanced). As shown in FIG. 5B, the personal information collected could include at least: Title 538, First Name 540, Last Name 542, Date of Birth 544, Marital Status 546, and Location 548. As shown in FIG. 5B, the work information collected could include at least: Company 550, Job Title 552, and Comments 554. After the designer is satisfied with the entry of profile information, the designer can proceed to the next section by selecting proceed-forward button 532. To exit the persona creation tool, the user can select the proceed-backwards button 530 (twice) or the exit button 502. At any point, if the designer wants to generate the persona based on the currently supplied information, the designer selects button 534.

FIG. 5C depicts a display during a stage of use of the persona creation tool 500. FIG. 5C depicts a stage 510 in the navigation bar 504. In an example embodiment, stage 510 is labeled accordingly as, for example, “Personality.” In some embodiments, a directive text statement associated with stage 510 states “Enter your Personality.” Stage 510 includes a display section 518 that includes at least the selected picture from stage 506. Stage 510 further includes an interactive section having at least fields 564 and 566, as well as slidable input bars, or slidable scales, 556 to 562. Other similar methods of collecting or culling information related to personality in the interactive section should similarly be considered included. In an example embodiment, traits related to personality are made available along the slidable scales. The slidable scales each have two factors, on respective ends of the slidable scales, which are related to a respective trait. The designer can for each trait adjust the bar so that the trait is adjusted between the two factors. In FIG. 5C, slidable scale 556 is adjustable between a first factor, Casual User, and a second factor, Power User, for the trait User Frequency. Slidable scale 558 is adjustable between a first factor, Proactive, and a second factor, Reactive, for the trait Reactivity. Slidable scale 560 is adjustable between a first factor, Teamwork, and a second factor, Solitary, for the trait Collaboration Level. Slidable scale 562 is adjustable between a first factor, Innovative, and a second factor, Conservative, for the trait Degree of Comfort with Innovation. Also in the interactive section, the box 564 is receptive to a designer input regarding a goal related to the business concern, or a personal goal. Box 566 is receptive to designer input having other comments related to the Persona Personality. After the designer is satisfied with the entry of personality information, the designer can proceed to the next section by selecting proceed-forward button 532. To exit the persona creation tool, the user can select the proceed-backwards button 530 (three times) or the exit button 502. At any point, if the designer wants to generate the persona based on the currently supplied information, the designer selects button 534.

FIG. 5D depicts a display during a stage of use of the persona creation tool 500. FIG. 5D depicts a stage 512 in the navigation bar 504. In an example embodiment, stage 512 is labeled accordingly as, for example, “Tasks.” In some embodiments, a directive text statement associated with stage 512 states “Enter your Tasks.” Stage 512 includes a display section 518 that includes at least the selected picture from stage 506. Stage 512 further includes an interactive section having at least fields 568 and 574. Stage 512 further includes a search section 570 that allows for retrieval and selection of default, template, or stored tasks. The designer can, in fields 568, provide a brief explanation of individual tasks that the Persona must complete. In some embodiments, task suggestions are made as the designer begins to enter a task. Multiple fields 568 are available for a plurality of tasks to be entered. In an example embodiment, a maximum number of tasks can be entered. In search section 570 a designer can input key terms into a search bar to see what tasks are retrieved and available for entry. In another example embodiment, a designer can scroll down scroll bar 572 to view alphabetic key terms related to tasks and select tasks for entry into 568. Also in the interactive section, box 574 is receptive to designer input comments related to the Persona Tasks. After the designer is satisfied with the entry of tasks information, the designer can proceed to the next section by selecting proceed-forward button 532. To exit the persona creation tool, the user can select the proceed-backwards button 530 (four times) or the exit button 502. At any point, if the designer wants to generate the persona based on the currently supplied information, the designer selects button 534.

FIG. 5E depicts a display during a stage of use of the persona creation tool 500. FIG. 5E depicts a stage 514 in the navigation bar 504. In an example embodiment, stage 514 is labeled accordingly as, for example, “Pain Points.” In some embodiments, a directive text statement associated with stage 514 states “Enter your Pain Points.” Stage 514 includes a display section 518 that includes at least the selected picture from stage 506. Stage 514 further includes an interactive section having at least fields 576 and 582. Stage 514 further includes a search section 578 that allows for retrieval and selection of default, template, or stored pain points. The designer can, in fields 576, provide a brief explanation of individual pain points that the Persona experiences. In some embodiments, pain point suggestions are made as the designer begins to enter a pain point. Multiple fields 576 are available for a plurality of pain points to be entered. In an example embodiment, a maximum number of pain points can be entered. In search section 578 a designer can input key terms into a search bar to see what pain points are retrieved and available for entry. In another example embodiment, a designer can scroll down scroll bar 580 to view alphabetic key terms related to pain points and select pain points for entry into 576. Also in the interactive section, box 582 is receptive to designer input comments related to the Persona Pain Points. After the designer is satisfied with the entry of pain points information, the designer can proceed to the next section by selecting proceed-forward button 532. To exit the persona creation tool, the user can select the proceed-backwards button 530 (five times) or the exit button 502. At any point, if the designer wants to generate the persona based on the currently supplied information, the designer selects button 534.

FIG. 5F depicts a display during a stage of use of the persona creation tool 500. FIG. 5F depicts a stage 516 in the navigation bar 504. In an example embodiment, stage 516 is labeled accordingly as, for example, “Needs.” In some embodiments, a directive text statement associated with stage 516 states “Enter your Needs.” Stage 516 includes a display section 518 that includes at least the selected picture from stage 506. Stage 516 further includes an interactive section having at least fields 584 and 590. Stage 516 further includes a search section 586 that allows for retrieval and selection of default, template, or stored needs. The designer can, in fields 584, provide a brief explanation of individual needs of the Persona. In some embodiments, needs suggestions are made as the designer begins to enter a need. Multiple fields 584 are available for a plurality of needs to be entered. In an example embodiment, a maximum number of needs can be entered. In search section 586 a designer can input key terms into a search bar to see what needs are retrieved and available for entry. In another example embodiment, a designer can scroll down scroll bar 588 to view alphabetic key terms related to needs and select needs for entry into 584. Also in the interactive section, box 590 is receptive to designer input comments related to the Persona Needs. After the designer is satisfied with the entry of needs information, the designer can proceed to the next section by selecting proceed-forward button 532. To exit the persona creation tool, the designer can select the proceed-backwards button 530 (six times) or the exit button 502. At any point, if the designer wants to generate the persona based on the currently supplied information, the designer selects button 534.

FIG. 5G depicts a display during a stage of use of the persona creation tool 500. FIG. 5G depicts a resultant Persona Profile. The resultant persona profile includes a display section 518 that includes at least the selected picture from stage 506. The resultant persona profile further includes a detailed profile section 592. The detailed profile section 592 includes a summary of the information collected in stages 506 to 516. In an example embodiment, the summary is in paragraph form and details a story of the Persona. In another example embodiment, the summary is in bullet form. In another example embodiment, in addition to and as a supplement to the summary, the information collected from the persona creation tool is culled and stored as reference information in a database, field by field, for use in another application. The designer can export information stored related to the persona by selecting button 594. To exit the persona creation tool, the user designer can select the exit button 502. At any point, if the designer wants to update the generated Persona Profile, the designer selects button 534.

The stages shown in navigator bar 504 need not necessarily be completed or organized in the manner presented in FIG. 5. The stages can be completed in any order, and stages can be added or removed as needed by the designer. At any point during the generation of the persona using persona creation tool 500, the designer can exit the persona creation tool by selecting the exit box 502. In addition, the designer can save the current state of the persona creation by selecting save icon 528. In some example embodiments, the fields and data from the persona creation tool 500 is automatically saved at regular intervals. In some example embodiments, the fields and data from the persona creation tool 500 is automatically saved upon certain actions by the designer, such as entry of text into a field. During the creation of the persona, the designer can further select, at any point, button 534 to generate the persona based on the entered information 534. Therefore, the designer need not enter in all information in order to create the persona. Icon 526 further identifies to the designer whether or not the persona creation tool 500 has identified similar personas, from within the user's team or business, that the designer can (or should) review. By selecting 526, at any point during the creation (e.g., 506 to 516), the designer can view the similar personas or select to adopt one of the previously created personas as the current persona. In an example embodiment of the platform, different personas need to be generated to represent different goals during the design process.

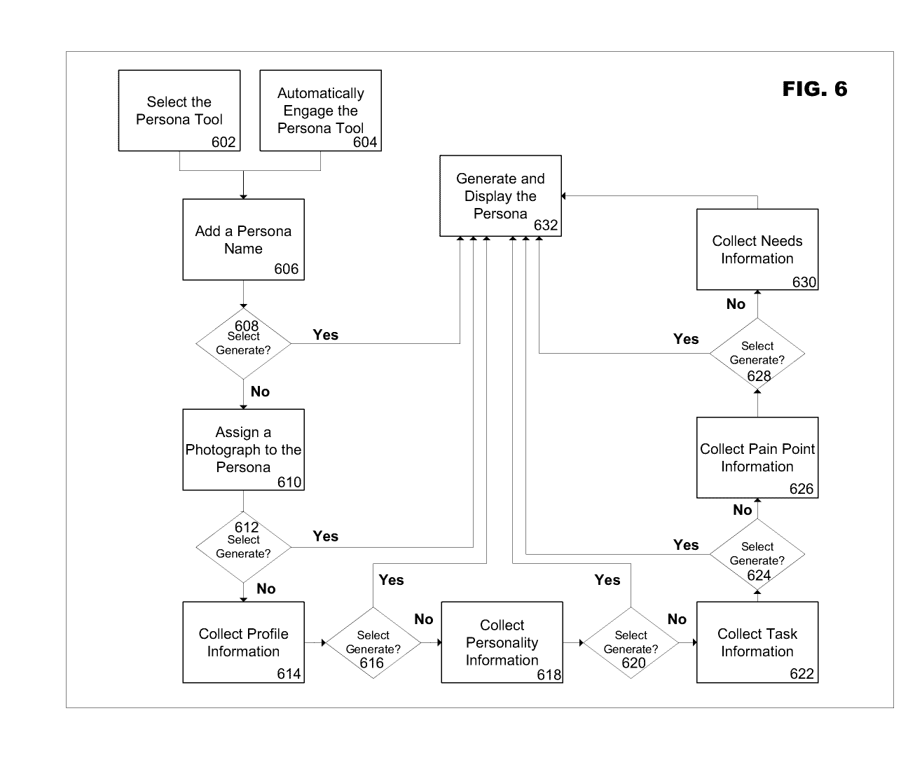

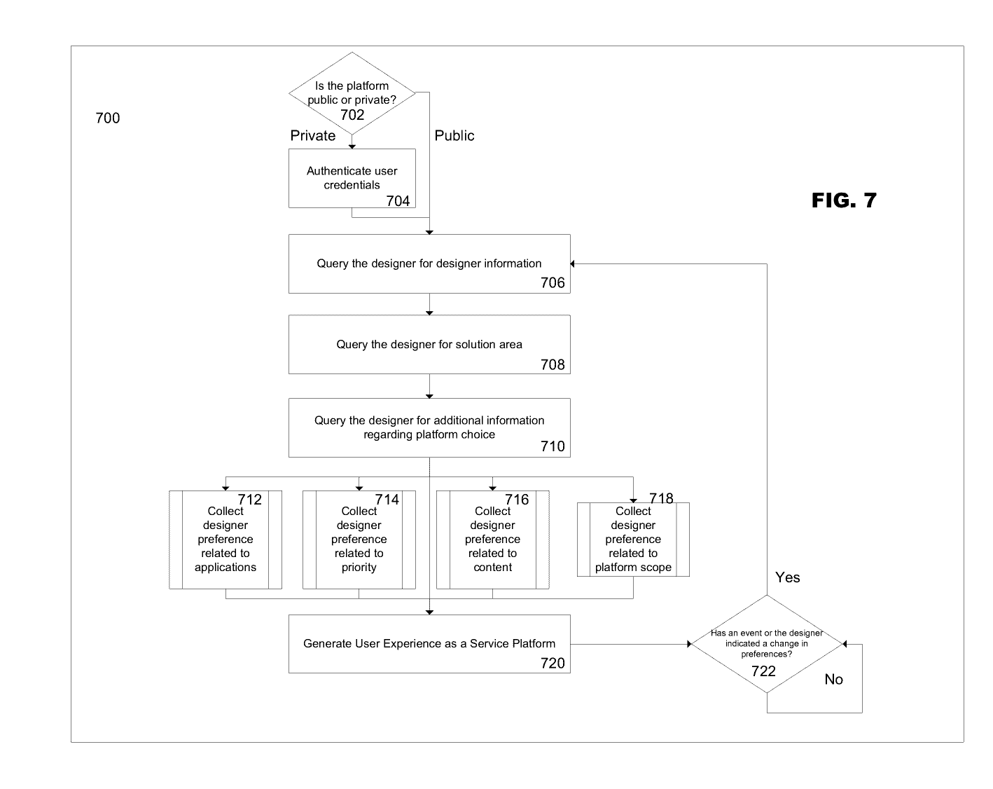

FIG. 6 describes the process 600 for creating an example persona on the user experience as a service platform. The designer is prompted, through the persona creation tool described in FIGS. 5A to 5G, to enter a variety of criteria regarding the ideal or typical end user for a particular product or service. Following completion of process 600, the designer has generated a persona of the end user that can be shared for collaboration purposes with other members of a team. The persona can be in written form, graphic form, mixed written and graphic, editable, and can further be considered an artifact of the design process.

In 602, the designer selects the persona tool from the main screen. In some embodiments, due to the step by step nature of the tool, the persona tool is referred to as a persona wizard. As an alternative to 602, in 604, the persona tool is automatically engaged to open upon initiation of a new design project. In 606, which follows either 602 or 604, the designer adds the name of the persona. The designer clicks in the appropriate section of the prompt and provides the desired name of the persona. After the name of the persona is entered, the designer submits the name of the persona through a carriage return or by clicking a proceed icon.

In 610, the designer selects a photograph that is to be assigned to the persona. A database or a collection of stock photographs can be made available for selection at this portion of the wizard. In some embodiments, the user can upload a photograph or a picture to be assigned to the persona from his or her personal computing device or an associated cloud database. After selection of the photograph, the designer submits the photograph through a carriage return or by clicking a proceed icon.

In 614, other information needed to generate the persona is collected. In an example embodiment, such information includes: i) a Title; ii) a First Name; iii) a Last Name; iv) a Date of Birth; v) Marital Status; vi) Location; vii) Company; and viii) Job Title. Other similar information relating to hypothetical personal information and hypothetical career information would similarly be collected at this particular point in time. Such similar information might include the industry in which the company is involved and the people to which the end user reports (i.e., customers or internal management). After entry or designation of the 608 criteria, the personal information is submitted through a carriage return or by clicking a proceed icon.

In 618, information relating to the end user's personality is collected. Such personality information can be collected in a variety of ways. In an example embodiment, traits related to personality are made available along slidable scales, between two factors related to a respective trait, so that the designer can selectively slide a bar along the scale to adjust the trait appropriately. For example, the slidable scales could include: User Frequency, Reactivity, Collaboration Level, and Degree of Comfort with Innovation. The trait of User Frequency is scaled between a factor of a casual user and a factor of a power user. The trait of Reactivity is scaled between a factor of proactive user and a factor of reactive user. The trait of Collaboration level is scaled between a factor of works in team and a factor of lone fighter. The trait of Degree of Comfort with Innovation is scaled between a factor of innovative and a factor of conservative. In an example embodiment, information related to personality is collected in a prompt from the designer. In an example embodiment, the prompt is specifically related to a goal for the persona, and is prompted by text associated with a text box such as “Say something about your goal in one sentence.” Other similar information relating to personality would similarly be collected at this particular point in time. Such similar information might include weighing the factors of: millennial v. baby boomer, technology trendsetter v. technology follower, extravert v. introvert, and budget minded v. free spender. After entry or designation of the 618 criteria, the criteria is submitted through a carriage return or by clicking a proceed icon.

In 622, tasks which the end user must complete are collected. In an example embodiment, a designer enters the tasks into a text box and selects a key or hits return after each task, thereby allowing for entry of multiple tasks. In an example embodiment, a maximum number of tasks related to the persona is set, such that if the number of tasks nears the maximum, a warning is displayed. In another example embodiment, the designer is provided with a warning once the maximum number of tasks is reached. In another example embodiment, a list of tasks is saved in memory and displayed to the designer as a template list of tasks from which the designer can select tasks for the end user. In an example embodiment, a designer can add a task to those saved in memory for the next iteration of creation of a persona. Other similar information relating to tasks would similarly be collected at this particular point in time. After entry or designation of the 612 criteria, the criteria is submitted through a carriage return or by clicking a proceed icon.

In 626, pain points are entered for which the end user must mind when reaching goals or to which the end user must pay extreme caution. In an example embodiment, a designer enters the pain points into a text box and selects a key or hits return after each pain point, thereby allowing for entry of multiple pain points. In an example embodiment, a maximum number of pain points related to the persona is set, such that if the number of pain points nears the maximum, a warning is displayed. In another example embodiment, the designer is provided with a warning once the maximum number of pain points is reached. In another example embodiment, a list of pain points is saved in memory and displayed to the designer as a template list of pain points from which the designer can select pain points for the end user. In an example embodiment, a designer can add a pain point to those saved in memory for the next iteration of creation of a persona. Other similar information relating to pain points would similarly be collected at this particular point in time. After entry or designation of the 614 criteria, the designer submits the criteria through a carriage return or by clicking a proceed icon.

In 630, needs are entered for which that the end user must mind when reaching goals. In an example embodiment, a designer enters the needs into a text box and selects a key or hits return after each need, thereby allowing for entry of multiple needs. In an example embodiment, a maximum number of needs related to the persona is set, such that if the number of needs near the maximum, a warning is displayed. In another example embodiment, the designer is provided with a warning once the maximum number of needs is reached. In another example embodiment, a list of needs is saved in memory and displayed to the designer as a template list of needs from which the designer can select needs for the end user. In an example embodiment, a designer can add a need to those saved in memory for the next iteration of creation of a persona. Other similar information relating to needs would similarly be collected at this particular point in time. After entry or designation of the 616 criteria, the designer submits the criteria through a carriage return or by clicking a proceed icon.

After each of 606, 610, 614, 618, 622, 626, and 630, the designer has an opportunity to generate the persona. At each opportunity, the designer can select to either generate the persona or proceed with entering criteria. Even after generating the persona, the designer can still return to and edit any of the criteria from 606, 610, 614, 618, 622, 626, and 630. In each of 606, 610, 614, 618, 622, 626, and 630, fields are automatically saved as they are updated by the designer, even prior to the designer selecting to proceed to the next step. In some example embodiments, changes are saved on predetermined events. A change event occurs whenever the designer enters or edits criteria, or when the designer leaves a section of the navigation to proceed to another section. In an example embodiment, the navigation between 606, 610, 614, 618, 622, 626, and 630 is scrambled from the version described above. The fields need not necessarily be entered in the same order. A designer can proceed through the pages or the process modules in a sequential order or the user can select from the navigation process flow bar at the top of the screen a portion of the wizard that the designer wishes to edit. In some embodiments, arrows or other directionality icons included on the processes can be used to step the designer forward or backwards through process entries. In an example embodiment, if the designer clicks on the photograph, the designer is returned to the first stage. In an example embodiment, the designer can exit the navigation through the wizard at any point by selecting a close icon or a done icon on the process. In 632, the persona is generated based on the criteria entered by the designer from 606 to 630.

FIG. 7 describes the process 700 for configuring a design platform to a user's needs while addressing a business concern. In order to provide a dynamic and interactive user experience as a service platform, process 700 is described in further detail. At least 704 and 722 are optional in process 700. Similarly, execution of all of 712, 714, 716, and 718 as part of 710 is not necessary and instead execution of at least one of 712, 714, 716, and 718 is provided for. In some example embodiments, execution of all of 712, 714, 716, and 718 is necessary.

In 702, public user experiences as a service platforms are distinguished from private platforms. Additional authentication and security measures may be required for successful implementation of private platforms, as shown in the authentication of user credential step 704. If the platform is public, authentication does not necessarily need to occur. In an example embodiment, however, authentication of user credentials is still provided for public platforms.

After any necessary authentication is completed, the user is queried for information. In 706, the designer is queried for designer information. In 708, the designer is queried for information regarding the solution area. In 710, the designer is queried for information regarding platform choices. Subprocesses 712 to 718 are subsumed by 710. 706, 708, and 710 can be implemented in any order, and not all of 706, 708, and 710 are necessarily completed.

In an example embodiment, in 706, 708, and 710 the information from the designer is not queried but is instead collected from a form or an external database. In another example embodiment, the information is culled from social media websites and associated databases, or employer databases. The platform harnesses a connection to a social media server and leverages the connections available through the social media provider for the platform. For example, all social media contacts within a certain circle or group are automatically integrated into a design team on the platform. Designer information includes information similar to the information such as name, age, place of business, residence, current location, job title, and other similar designer specific features. Solution areas include information displayed in greater detail in FIG. 2B, and can include, as an example, information that the designer is looking to address a business concern related to Human Resources. Solution areas further include sub-categories of solution areas and any information nested into the solution areas. Platform choice includes information displayed in greater detail in FIGS. 2C to 2E, and those additional features described throughout the foregoing.

With reference to 712, information regarding a designer's preference for specific design based applications is collected. In an example embodiment, information collected includes preferences for applications, familiarity of languages used by applications, and desire to explore new unfamiliar applications. With reference to 714, information regarding a designer's priority preferences is collected. In an example embodiment, information collected includes the designer's preference to participate in discussions only and to not participate in any design challenges or environments. With reference to 716, information regarding a designer's preference for content is collected. In an example embodiment, information collected includes preferences for specific artifacts (e.g., persona profiles and use cases) that are of interest to the designer. With reference to 718, information regarding a designer's preference for platform scope is collected. In an example embodiment, information collected includes the designer preferences for the scope of design presented on the platform. In an example embodiment, a designer indicates a preference for involvement in tasks only related to design and not development of an artifact. The scope of data presented on the platform is limited to provide applications, content, and trajectories of learning that only extend within the scope indicated by the designer's preference.

After any necessary preference information, designer information, and solution area information is collected, the platform is generated in 720. The generated platform is in an example embodiment made available instantly for the designer's use and is displayed to the designer. Over time, at regular intervals or upon predetermined events, the platform is analyzed to determine whether or not there is a change in any of the criteria analyzed in 706, 708, and 710. Such a change might include an advancement in the designer's understanding of an application or a programming language. If there is a change indicated in 722, then the information in 706, 708, and 710 is dynamically collected and analyzed to update the user experience as a platform.

It should be appreciated that the present invention can be implemented in numerous ways, including as a process, an apparatus, a system, a computer processor executing software instructions, or a computer readable medium such as a non-transitory computer readable storage medium, or a computer Network wherein program instructions are sent over optical or electronic communication or non-transitory links. It should be noted that the order of the steps of disclosed processes can be altered within the scope of the invention, as noted in the appended claims and in the description herein.

Although the foregoing embodiments have been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. For the purpose of clarity, technical material that is known in the technical fields related to the invention has not been described in detail so that the present invention is not unnecessarily obscured.

It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A system for configuring a design platform to assist an end user in a design process, the system comprising:
at least one server having a processing device, the processing device:
querying the end user for end user information;
querying the end user for at least one solution area relating to a business concern of the end user;
querying the end user for additional information regarding at least one configuration preference for the design platform;
retrieving information from at least one additional server data related to at least one of:
the queried end user information,
the queried solution areas, and
the queried additional information regarding configuration preferences; and
generating, on a networked client device, the design platform according to the retrieved information.

2. The system as recited in claim 1, the system further comprising:
the processing device:
collecting at least one configuration preference related to:
i) applications available on the design platform,
ii) priority for participation in at least two environments available on the design platform,
iii) content available on the design platform, and
iv) scope of tasks available on the design platform.

3. The system as recited in claim 1, the system further comprising:
the processing device:
determining, from the retrieved information related to the queried additional information, whether at least one of:
i) the end user has indicated a change in the additional information regarding at least one configuration preference, and
ii) the end user has engaged in a predetermined event.

4. The system as recited in claim 3, wherein the predetermined event is one of: obtaining a badge, completion of an online course demonstrating an understanding of an application or a programming language, and generating an artifact.

5. The system as recited in claim 1, the system further comprising:
the processing device:
hosting, on the generated design platform, at least one end user design wizard that guides the end user through a portion of the design process by:
prompting the user to enter a variety of criteria related to the portion of the design process, and
generating an artifact for the portion of the design process.

6. The system as recited in claim 5, wherein the at least one end user design wizard is a persona creation tool,
wherein the persona creation tool prompts the user to enter the variety of criteria for a persona including: i) a name for the persona, ii) a photograph for the persona, iii) profile information for the persona, iv) personality information for the persona, v) task information for the persona, vi) pain points for the persona, and vii) needs for the persona, and
wherein the persona creation tool generates after one of any or all of (i) to (vii), as the artifact, a persona display.

7. The system as recited in claim 1, the system further comprising:
the processing device:
collecting from the end user information log on credentials;
determining, based on the log on credentials, whether a desired design platform is a public design platform or a private design platform; and
responsive to the desired design platform being a private design platform, authenticating the log on credentials before generating the design platform.

8. A method for configuring a design platform to assist an end user in a design process, the method comprising:
querying the end user for end user information;
querying the end user for at least one solution area relating to a business concern of the end user;
querying the end user for additional information regarding at least one configuration preference for the design platform; and
generating the design platform according to at least one response from the query for the at least one solution area and the query for additional information.

9. The method as recited in claim 8, the method further comprising:
determining whether at least one of:
i) the end user has indicated a change in additional information regarding at least one configuration preference, and
ii) the end user has engaged in a predetermined event.

10. The method as recited in claim 8, the querying the additional information further comprising:
collecting at least one configuration preference related to: i) applications available on the design platform, ii) priority for participation in at least two environments available on the design platform, iii) content available on the design platform, and iv) scope of tasks available on the design platform.

11. The method as recited in claim 8, the method further comprising:
collecting from the end user information log on credentials;
determining, based on the log on credentials, whether a desired design platform is a public design platform or a private design platform; and
responsive to the desired design platform being a private design platform, authenticating the log on credentials before generating the design platform.

12. The method as recited in claim 9, wherein:
the predetermined event is one of: obtaining a badge, completion of an online course demonstrating an understanding of an application or a programming language, and generating an artifact.

13. The method as recited in claim 8, further comprising:
hosting, on the generated design platform, at least one end user design wizard that guides the end user through a portion of the design process by:
prompting the user to enter a variety of criteria related to the portion of the design process, and
generating an artifact for the portion of the design process.

14. The method as recited in claim 13, wherein the at least one end user design wizard is a persona creation tool,
wherein the persona creation tool prompts the user to enter the variety of criteria for a persona including: i) a name for the persona, ii) a photograph for the persona, iii) profile information for the persona, iv) personality information for the persona, v) task information for the persona, vi) pain points for the persona, and vii) needs for the persona, and
wherein the persona creation tool generates after one of any or all of (i) to (vii), as the artifact, a persona display.

15. A non-transitory computer readable storage device storing program instructions that, when executed, cause a processing device to perform a method for configuring a design platform to assist an end user in a design process, the method comprising:
querying the end user for end user information;
querying the end user for at least one solution area relating to a business concern of the end user;
querying the end user for additional information regarding at least one configuration preference for the design platform;
generating the design platform according to at least one response from the query for the at least one solution area and the query for additional information; and
hosting, on the generated design platform, at least one end user design wizard that guides the end user through a portion of the design process by:
prompting the user to enter a variety of criteria related to the portion of the design process, and
generating an artifact for the portion of the design process.

16. The non-transitory computer readable storage device as recited in claim 15, wherein:
the at least one end user design wizard is a persona creation tool,
the persona creation tool prompts the user to enter the variety of criteria for a persona including: i) a name for the persona, ii) a photograph for the persona, iii) profile information for the persona, iv) personality information for the persona, v) task information for the persona, vi) pain points for the persona, and vii) needs for the persona, and
the persona creation tool generates after one of any or all of (i) to (vii), as the artifact, a persona display.

17. The non-transitory computer readable storage device as recited in claim 15, the method further comprising:
collecting at least one configuration preference related to: i) applications available on the design platform, ii) priority for participation in at least two environments available on the design platform, iii) content available on the design platform, and iv) scope of tasks available on the design platform.

18. The non-transitory computer readable storage device as recited in claim 15, the method further comprising:
determining, from the retrieved information related to the queried additional information, whether at least one of:
i) the end user has indicated a change in the additional information regarding at least one configuration preference, and
ii) the end user has engaged in a predetermined event.

19. The non-transitory computer readable storage device as recited in claim 18, wherein the predetermined event is one of: obtaining a badge, completion of an online course demonstrating an understanding of an application or a programming language, and generating an artifact.

20. The non-transitory computer readable storage device as recited in claim 15, the method further comprising:
collecting from the end user information log on credentials;
determining, based on the log on credentials, whether a desired design platform is a public design platform or a private design platform; and
responsive to the desired design platform being a private design platform, authenticating the log on credentials before generating the design platform.
